(19) United States
(12) Patent Application Publication
(10) Pub. No.: US 2026/0245049 A1
(43) Pub. Date: Aug. 20, 2026

(54) AIRCRAFT SERVICE MANAGEMENT

(71) Applicant: Honeywell International, Inc., Charlotte, NC (US)

(72) Inventors: Karthikeyan M, Madurai (IN); Gobinathan Baladhandapani, Madurai (IN); Srilakshmi Kurudi, Bangalore (IN)

(21) Appl. No.: 19/182,656

(22) Filed: Apr. 18, 2025

(30) Foreign Application Priority Data
Feb. 17, 2025 (IN) 202511013579

(51) Int. Cl. G06Q 10/20; G06Q 10/1093

(52) U.S. Cl. CPC G06Q 10/20; G06Q 10/1097

(57) ABSTRACT

Techniques for managing aircraft service are described. In one example implementation, the present subject matter facilitates in generating a list of service airports from among a plurality of airports based on availability of one or more of the plurality of spare components at the plurality of airports and proximity of location of the plurality of airports to a flight route of the aircraft. Further, the list of service airports may be transmitted to a flight maintenance system of the aircraft for scheduling service of the one or more of the plurality of components in the serviceable window.

### BACKGROUND

Urban Air Mobility (UAM) is rapidly evolving as a transformative solution for transportation in congested urban environments and remote areas. UAM vehicles may include aerial vehicles such as helicopters, vertical take-off and landing (VTOL) aircraft, and unmanned aerial vehicles (UAVs). These aerial vehicles may be deployed in various applications, for example, urban air taxi services, emergency medical transport, surveillance, reconnaissance, mapping, and disaster relief operations.

### SUMMARY

This summary is provided to introduce concepts related to timely scheduling service of components in serviceable window and optimal stocking of inventories at airports used in urban air mobility (UAM). This summary is not intended to identify essential features of the claimed subject matter nor is it intended for use in determining or limiting the scope of the claimed subject matter.

In an aspect of the present subject matter, a method for timely scheduling service of components in serviceable window is disclosed. In the method, input data corresponding to at least one maintenance parameter for each of a plurality of components of an aircraft is processed to determine values of health parameters for each of the plurality of components of the aircraft. The input data is generated based on post-flight data obtained from latest flight of the aircraft. The health parameters are indicative of real-time condition and performance of each of the plurality of components. Further, the method includes obtaining real-time inventory data of a plurality of spare components corresponding to the one or more components in the serviceable window, on ascertaining one or more components, of the plurality of components, to be in a serviceable window based on an assessment of the health parameters. When the real-time inventory data is obtained, a list of service airports from among a plurality of airports is generated. The list of service airports is based on availability of one or more of the plurality of spare components at the plurality of airports and proximity of location of the plurality of airports to a flight route of the aircraft. Further, in the method, the list of service airports is transmitted to a flight maintenance system of the aircraft for scheduling service of the one or more of the plurality of components in the serviceable window.

In another aspect of the present subject matter, a system for optimal stocking of inventories at airports used in urban air mobility (UAM) is disclosed. The system includes a data processing engine and an inventory updating engine. The data processing engine obtains input data corresponding to at least one maintenance parameter for each of a plurality of components of an aircraft. The input data is generated based on post-flight data obtained from latest flight of the aircraft. Further, the data processing engine obtains historical operational data for each of the plurality of components of the aircraft. When both the input data and the historical operational data are available, the data processing engine processes the input data and the historical operational data to identify one or more components, from the plurality of components, requiring either a service prior to a scheduled service time or a replacement prior to a scheduled replacement time. Upon identifying the components requiring the service or the replacement, the inventory updating engine generates a replenishment notification indicative of replenishment of spare parts corresponding to the one or more of the plurality of components requiring the service or the replacement. Further, the inventory updating engine transmits the replenishment notification to an inventory management system associated with airports located in proximity to a flight route of the aircraft for optimally stocking inventories at the airports.

In yet another aspect of the present subject matter, a non-transitory computer readable medium for timely scheduling service of components in serviceable window is disclosed. The non-transitory computer readable medium has instructions stored thereon. The instructions, when executed by a processor, cause the processor to perform operations. In the operations, input data corresponding to at least one maintenance parameter for each of a plurality of components of an aircraft is processed to determine values of health parameters for each of the plurality of components of the aircraft. The input data is generated based on post-flight data obtained from latest flight of the aircraft, and the health parameters are indicative of real-time condition and performance of each of the plurality of components. On ascertaining one or more components, of the plurality of components, to be in a serviceable window based on an assessment of the health parameters, further in the operations, real-time inventory data of a plurality of spare components corresponding to the one or more components in the serviceable window is obtained and a list of service airports from among a plurality of airports is generated based on availability of one or more of the plurality of spare components at the plurality of airports and proximity of location of the plurality of airports to a flight route of the aircraft. Further, in the operations, the list of service airports is transmitted to a flight maintenance system of the aircraft for scheduling service of the one or more of the plurality of components in the serviceable window.

### BRIEF DESCRIPTION OF DRAWINGS

Systems and/or methods, in accordance with examples of the present subject matter are now described and with reference to the accompanying figures, in which:

FIG. 1 illustrates a system for optimally stocking inventories at the airports used in urban air mobility (UAM), according to an example;

FIG. 2 illustrates a network environment for aircraft service management, according to an example;

FIG. 3 illustrates an environment where a UAM vehicle is operating, according to an example;

FIG. 4 illustrates an environment where a UAM vehicle is operating, according to another example;

FIG. 5 illustrates a method for aircraft service management, according to an example;

FIG. 6 illustrates a method for aircraft service management, according to another example;

FIG. 7 illustrates an exemplary implementation where the input data and the historical operational data are processed, according to an example;

FIG. 8 illustrates a non-transitory computer readable medium for aircraft service management, according to an example.

### DETAILED DESCRIPTION

Despite evolving as a transformative solution for transportation in congested urban environments and remote areas, aircraft maintenance in urban air mobility (UAM) faces significant challenges in optimizing spare parts inventory due to complex factors affecting demand and supply. These include data quality issues, demand variability, and supply uncertainties. The lack of an optimized inventory management system leads to inefficiencies in aircraft availability, reliability, safety, and overall operational readiness. This results in increased costs and reduced service levels for the aviation industry. In addition, ascertaining the serviceable components of an aircraft and identifying the airport with the feasible inventory are problematic areas in the aviation industry catering the UAM.

Data quality issues stem from inconsistent or incomplete maintenance records, inaccurate part tracking, and outdated inventory systems. These problems make it difficult to accurately predict future spare parts needs and lead to either overstocking or understocking of critical components. Demand variability is influenced by factors such as aircraft usage patterns, seasonal fluctuations, unexpected failures, and changes in maintenance schedules. This unpredictability complicates inventory forecasting and can result in sudden shortages or excess inventory.

The lack of an optimized inventory management system leads to several negative outcomes including reduced aircraft availability due to extended maintenance downtime while waiting for parts and potential safety risks if proper parts are not available for critical repair. The lack of optimized ascertaining of the serviceable components of the aircraft leads to potential risks to the aircraft safety. The aviation industry's service levels are compromised when these inventory management issues lead to flight delays, cancellations, or reduced fleet flexibility.

Approaches of the present subject matter facilitates timely scheduling service of components in serviceable window and optimal stocking of inventories at airports used in urban air mobility (UAM). In an implementation of the present subject matter, input data corresponding to a maintenance parameter of components of an aircraft may be processed. The processing is performed to determine values of health parameters for each component of the aircraft. The health parameters of each component of the aircraft are critical for the aircraft safety as they are indicative of real-time condition and performance of each component. In an example, the input data is generated based on post-flight data obtained from latest flight of the aircraft. In an example, the post-flight data is based on one or more of flight hours, fuel consumption, engine operating parameters, environmental conditions, maintenance actions, and faults in the components.

On ascertaining few components of the aircraft to be in a serviceable window based on an assessment of the health parameters, real-time inventory data of spare components may be obtained. The spare components are corresponding to the components in the serviceable window so that the spare components can be used either for the repair or for complete replacement of the components in the serviceable window.

When the components in the serviceable window and the real-time inventory data of spare components are available, a list of service airports may be generated based on availability of the spare components. The service airports may be airports in proximity of location of the plurality of airports to a flight route of the aircraft and where the desired spare component is available. The list of service airports may be transmitted to a flight maintenance system of the aircraft for scheduling service of the components in the serviceable window.

Based on the awareness of the service airports and the components in the serviceable window, a maintenance schedule can be optimally created either by the pilot of the aircraft or by the flight maintenance system in an auto-setting mode. The maintenance schedule includes optimal service times and locations for the components to be serviced or replaced. The flight route of the aircraft can be updated to incorporate the maintenance schedule for ensuring minimal disruption to the aircraft's operational schedule. The present subject matter ensures continuous monitoring the health parameters of the components during flight and updating the maintenance schedule in real-time if any changes in component health are detected. The present invention ensures a balance between criticality to aircraft safety and operational efficiency. The analysis of the post-flight data helps in predicting future maintenance needs and optimizing the maintenance schedule. The approach is data-driven and proactive to spare component management.

In another implementation of the present subject matter, input data corresponding to a maintenance parameter for each component of an aircraft may be obtained. The input data may be generated based on post-flight data obtained from latest flight of the aircraft, i.e., most recent flight's post-flight data. Further, historical operational data for each component of the aircraft may be obtained. After obtaining the input data and the historical operational data, both are processed to identify one or more components of the aircraft requiring either a service prior to a scheduled service time or a replacement prior to a scheduled replacement time. Further, on identifying any such component, i.e., for service or replacement, a replenishment notification indicative of replenishment of spare parts corresponding to the components requiring the service or the replacement may be generated and the same is transmitted to an inventory management system associated with airports located in proximity to a flight route of the aircraft for optimally stocking inventories at the airports. This implementation aims to improve aircraft maintenance efficiency by predicting component needs based on real-time and historical data, while also optimizing spare part inventory management across relevant airports. This implementation enhances spare components availability and service levels by ensuring the right components are in the right place at the right time.

The present subject matter addresses the challenge of optimizing spare parts inventory for aircraft maintenance, which is complicated by factors such as data quality issues, demand variability, and supply uncertainties. The approaches of the present subject matter enable proactive, data-driven maintenance planning and inventory management, potentially improving aircraft reliability, reducing costs, and enhancing operational efficiency in the aviation industry. The approaches of the present subject matter optimizes aircraft spare parts inventory using advanced data analytics and machine learning techniques, for example, by utilization of post-flight data analytics to assess real-time condition and performance of aircraft components, application of machine learning algorithms to forecast spare parts demand and optimize inventory levels, consideration of multiple objectives and constraints in the optimization process, including cost minimization, service level maximization, and meeting availability and reliability requirements.

The present subject matter ensures provision of a flexible and adaptive framework capable of handling various aircraft types, components, and data sources, with the ability to update and improve based on new data and algorithms. This invention aims to enhance the efficiency and effectiveness of aircraft spare parts inventory management by leveraging real-time data and advanced predictive techniques. The present subject matter is developing a multi-objective optimization model that balances cost, service level, and reliability, for example, by dynamically adjusting inventory recommendations based on changing demand patterns and operational requirements. All the advantages of the present subject matter collectively contribute to more effective aircraft maintenance operations, cost savings, and improved overall performance in the aviation industry.

The present subject matter is further described with reference to the accompanying figures. Wherever possible, the same reference numerals are used in the figures and the following description to refer to the same or similar parts. It should be noted that the description and figures merely illustrate principles of the present subject matter. It is thus understood that various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

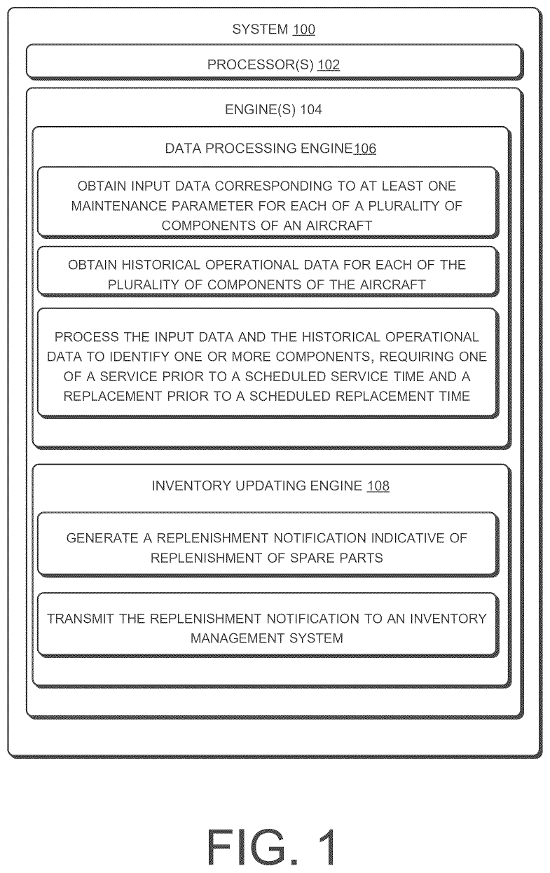

FIG. 1 illustrates a system 100 for optimally stocking inventories at the airports (not shown in FIG. 1) used in urban air mobility (UAM), according to an example. Examples of the system 100 may include, but are not limited to, a laptop, a notebook computer, a server computer, a tablet computer, and a smartphone. Inventories are indicative of spare parts required for aircraft maintenance, repair, and operation. Urban Air Mobility (UAM) is used for transportation in congested urban environments and remote areas. UAM vehicles may include aerial vehicles such as helicopters, vertical take-off and landing (VTOL) aircraft, and unmanned aerial vehicles (UAVs). These aerial vehicles may be deployed in various applications, for example, urban air taxi services, emergency medical transport, surveillance, reconnaissance, mapping, and disaster relief operations.

The system 100 may include processor(s) 102. The processor(s) 102 may include microprocessors, microcomputers, microcontrollers, digital signal processors, central processing units, state machines, logic circuitries, and/or any other devices that manipulate signals and data based on computer-readable instructions. Further, functions of the various elements shown in the figures, including any functional blocks labelled as “processor(s)”, may be provided through the use of dedicated hardware as well as hardware capable of executing computer-readable instructions. In one example, the system 100 may be a standalone server or may be a remote server on a cloud computing platform. In a preferred example, the system 100 may be a cloud-based system. The system 100 is capable of delivering applications (such as cloud applications) for managing an aerial vehicle environment.

The system 100 may further include engine(s) 104. The engine(s) 104 may be implemented as a combination of hardware and programming, for example, programmable instructions to implement a variety of functionalities of the engine(s) 104. In examples described herein, such combinations of hardware and programming may be implemented in several different ways. For example, the programming for the engine(s) 104 may be executable instructions. Such instructions may be stored on a non-transitory machine-readable storage medium which may be coupled either directly with the system 100 or indirectly (for example, through networked means). In an example, the engine(s) 104 may include a processing resource, for example, either a single processor or a combination of multiple processors, to execute such instructions. In other examples, the engine(s) 110 may be implemented as electronic circuitry. The engine(s) 104 includes a data processing engine 106 and an inventory updating engine 108.

In operation, input data corresponding to at least one maintenance parameter for each of a plurality of components of an aircraft is received by the data processing engine 106 of the system 100. The input data may be generated based on post-flight data obtained from latest flight of the aircraft, i.e., most recent flight's post-flight data. In an example, the post-flight data is based on one or more of flight hours, fuel consumption, engine operating parameters, environmental conditions, maintenance actions, and faults in the components. The input data generated based on the post-flight data is a real-time indicative of state of components of the aircraft. Further, historical operational data for each component of the aircraft may be obtained. In an example, the historical operational data may be based on one or more of flight hours, fuel consumption, engine operating parameters, environmental conditions, maintenance actions, and faults in the components.

Further, the data processing engine 106 processes the input data and the historical operational data. The input data and the historical operational data are processed to identify one or more components of the aircraft requiring either a service prior to a scheduled service time or a replacement prior to a scheduled replacement time. The service prior to the scheduled service time indicates that the component is deteriorating in performance and needs servicing for its proper functioning. The replacement prior to the scheduled replacement time indicates that the component is on the verge of failure and immediate attention is required. In an example, if the aircraft is operating in extremely cold conditions, braking system of the aircraft may require either service prior to the scheduled service time or replacement prior to the scheduled replacement time.

When any such component requiring either service prior to the scheduled service time or replacement prior to the scheduled replacement time is identified by the data processing engine 106, the inventory updating engine 108 of the system 100 on receiving an intimation regarding the service or the replacement, generates a replenishment notification indicative of replenishment of spare parts corresponding to the components requiring the service or the replacement. The replenishment notification includes information of the component, such as part name, specification, etc. The inventory updating engine 108 further transmits the replenishment notification to an inventory management system (not shown) associated with airports located in proximity to a flight route of the aircraft for optimally stocking inventories at the airports. In an example, the inventory management system may be connected to the system 100, via a network such as Wi-Fi network. The inventory management system is at least one of an onboard inventory management system located onboard the aircraft or a remote inventory management system located remotely from the aircraft. In an example, if the flight route of the aircraft has 5 airports in its proximity, for example, within a 5-minute flying from the flight route, all the 5 airports will be intimated so that inventory management system associated with each of 5 airports may keep the inventory stock updated based on the actual predicted requirement. This implementation enhances spare components availability and service levels by ensuring the right components are in the right place at the right time.

In addition, each time the inventory management system receives the replenishment notification, a validation test may be performed on the replenishment notification to determine if the replenishment notification is authentic, i.e., not compromised, i.e., includes a malicious program, a virus, modified data, and/or any suspicious data.

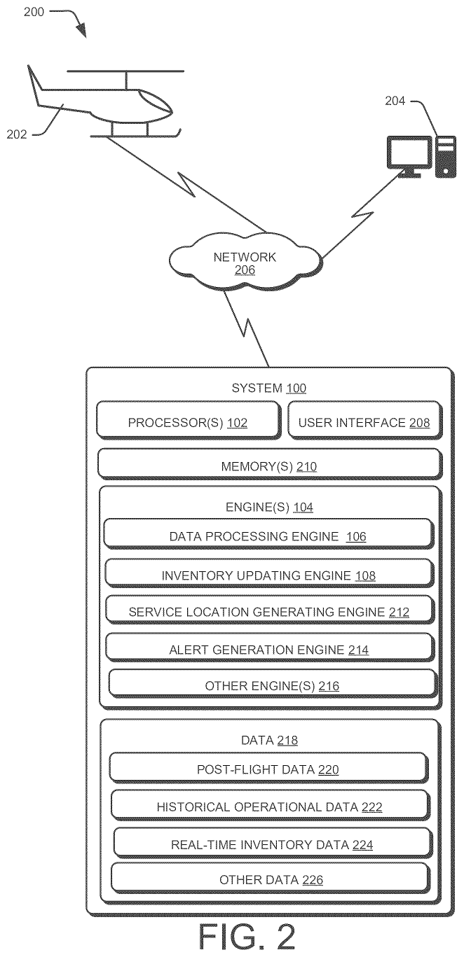

FIG. 2 illustrates a network environment 200 for aircraft service management, according to an example. The network environment 200 includes the system 100 for aircraft service management of an aircraft 202. The aircraft may be an urban air mobility (UAM) vehicle. Examples of UAM vehicle may include, but are not limited to, helicopters, vertical take-off and landing (VTOL) aircraft, and unmanned aerial vehicles (UAVs). The system 100 is described in FIG. 1 and may include, but is not limited to, a laptop, a notebook computer, a server computer, a tablet computer. In an example, an external management device, such as a portable electronic device, may be connected to the system 100 to assist flight crews in aircraft service management. The system 100 may include the processor(s) 102 similar to depicted in FIG. 1. Further, in an example, the system 100 may be connected to a database 204 through a network 206. The database 204 may be, for example, a structured query language (SQL) data store or a not only SQL (NoSQL) data store. In an exemplary implementation, the database 204 may be configured as cloud-based database implemented in the aviation environment. In another exemplary implementation, the database 204 may be a location on a file system directly accessible by the engines. The database 204 may be configured to store post-flight and historical flight data, program files used in the operation of the aircraft.

In an example, the database 204 may be a UAM database. In one example, the UAM database may be hosted virtually, for example, on a cloud-based platform. In another example, the UAM database may be a stand-alone physical system geographically located either on the site or close to the site. Examples of the site may include, but are not limited to, a building or any other working environments in any industry associated to the UAM vehicles. In an example the UAM database may be accessed on the system 100 by the user to obtain various UAM vehicle related details such as UAM vehicle performance data, UAM vehicle operational data, etc. In an example, the UAM database may be managed and owned by different entities and may be located at different geographical locations.

The network 206 may be a wireless network, a wired network, or a combination thereof. The network 206 can also be an individual network or a collection of many such individual networks, interconnected with each other and functioning as a single large network, e.g., the Internet or an intranet. Examples of such individual networks include, but are not limited to, local area network (LAN), wide area network (WAN), the internet, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), and Integrated Services Digital Network (ISDN). Depending on the technology, the network 206 may include various network entities, such as transceivers, gateways, and routers. The network 206 can be implemented as one of the different types of networks, such as intranet, local area network (LAN), wide area network (WAN), the internet, and such. The network 206 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other.

In one implementation, the network environment 200 may be an aviation network, including personal computers, laptops, various servers, such as blade servers, and other computing devices connected over the network 206. The system 100 includes the processor(s) 102. Further, the system 100 includes interface(s) 208 and memory(s) 210. The interface(s) 208 may allow the connection or coupling of the system 100 with one or more other devices, through a wired (e.g., Local Area Network, i.e., LAN) connection or through a wireless connection (e.g., Bluetooth®, Wi-Fi). The interface(s) 208 may also enable intercommunication between different logical as well as hardware components of the system 100.

The memory(s) 210 may be a computer-readable medium, examples of which include volatile memory (e.g., RAM), and/or non-volatile memory (e.g., Erasable Programmable read-only memory, i.e., EPROM, flash memory, etc.). The memory(s) 210 may be an external memory, or internal memory, such as a flash drive, a compact disk drive, an external hard disk drive, or the like. The memory(s) 210 may further include data which either may be utilized or generated during the operation of the system 100.

The engine(s) 104 of the system 100 may further include a service location generating engine 212, an alert generation engine 214, and other engines 216 in addition to the data processing engine 106 and the inventory updating engine 108 as depicted in FIG. 1. The service location generating engine 212, the alert generation engine 214, and other engines 216 may be implemented as a combination of hardware and programming, for example, programmable instructions to implement a variety of functionalities of the engine(s). In examples described herein, such combinations of hardware and programming may be implemented in several different ways. For example, the programming for the engine(s) may be executable instructions. Such instructions may be stored on a non-transitory machine-readable storage medium which may be coupled either directly with the system 100 or indirectly (for example, through networked means). In an example, the engine(s) may include a processing resource, for example, either a single processor or a combination of multiple processors, to execute such instructions. In other examples, the engine(s) may be implemented as electronic circuitry. The system 100 further include data 218. The data 218 includes post-flight data 220, historical operational data 222, real-time inventory data 224, and other data 226. In an example, the historical operational data 222 may include information from historical flights undertaken by one or more UAM vehicles over a flight path. In an example, the flight information may include operational state records of components of the UAM vehicles. The flight information may further include flight plans, weather data, navigation data, performance metrics, air traffic control (ATC) instructions, safety and compliance records, passenger and cargo information, emergency procedures etc. In an example, the post-flight data 220 may include flight data by the UAM vehicles generated after every flight. In an example, the other data 226 may include UAM vehicle data and other data generated by the other engine(s) 216. It may be noted that such examples are only indicative. The present approaches may be applicable to other examples without deviating from the scope of the present subject matter.

The network environment 200 is in operation once the aircraft 202 is ready for the operation and connected to the system 100. For example, the network environment 200 is in operation when the aircraft 202 is on a runway or a launch pad and is ready for take-off. For example, the network environment 200 is in operation when the aircraft 202 is flying on a specified flight route.

In an example, the system 100 may be operated by a user for UAM vehicle communication. In an example, the user may be a pilot of an UAM vehicle. In another example, the user may be a UAM vehicle operator associated with an UAM vehicle organization. For instance, the UAM vehicle operator may monitor and operate multiple UAM vehicles flying on a target flight path. In an example, the system 100 may automatically operate the UAM vehicle communication process upon initiating. In another example, the system 100 may operate manually based on inputs provided by the user.

Initially, the data processing engine 106 of the system 100 may receive input data corresponding to at least one maintenance parameter for each of a plurality of components of an aircraft. The maintenance parameter may be a measurable characteristic or indicator used to assess the condition, performance, or reliability of an aircraft component. This could include metrics such as operating temperature, vibration levels, electrical current draw, or fluid pressure. The components may include avionics including, but is not limited to, flight management systems, engine controls, flight control systems, navigation, communications, flight recorders, lighting systems, threat detection, fuel systems, electro-optic systems, weather radar, etc. The input data may be generated based on post-flight data obtained from latest flight of the aircraft, i.e., most recent flight's post-flight data. The post-flight data can be extracted and stored in the database during post flight analytics. The data collection can be from aircraft sensors, logs, and reports. The data collection can also be from passenger feedback, crew reports, fuel consumption, and maintenance records. In an example, the post-flight data is based on one or more of flight hours, fuel consumption, engine operating parameters, environmental conditions, maintenance actions, and faults in the components. The post-flight data is the information collected during and after a flight that provides insights into the aircraft's performance and component health. This can encompass a wide range of data types, from engine performance metrics to cabin environmental conditions. The input data generated based on the post-flight data is a real-time indicative of state of components of the aircraft. In an example, the data processing engine 106 may obtain the post-flight data utilizing a post-flight analytical technique. In an example, the post-flight analytical technique may be selected from a descriptive analytical technique, a predictive analytical technique, and a prescriptive analytical technique. The descriptive analytical technique can help summarize the past performance and trends of the inventory, such as the average consumption, wastage, and demand of each item. The predictive analytical technique can help forecasting the future demand and supply of the inventory, based on factors such as seasonality, weather, route, flight duration, and passenger profile. The prescriptive analytical technique can help generating optimal recommendations and actions for the inventory, such as the optimal quantity, quality, and variety of each item, as well as the optimal price, promotion, and placement of the items. The post flight data analytics captures the real-time condition and performance of the aircraft components, which can reflect the actual and potential demand of spare parts.

Additionally, the data processing engine 106 may apply a relevancy filter to the post-flight data for filtering data corresponding to the at least one maintenance parameter for each of the plurality of components of the aircraft. The relevancy filter is applied to remove noise from the post-flight data so that unnecessary computation of the unnecessary data may be avoided. The relevancy filter may be an algorithmic process that evaluates incoming data to determine its significance or relevance to specific maintenance parameters or decision-making processes. This helps in reducing data noise and focusing on the most critical information.

In an example, the relevancy filter may utilize various techniques to assess data relevance, such as statistical analysis, machine learning algorithms, or predefined thresholds. For example, it may compare incoming data values against historical norms or expected ranges for each maintenance parameter. Data points that fall within normal ranges or exhibit expected patterns may be filtered out, while those that deviate significantly or indicate potential issues are retained for further analysis. The filtered post-flight data is then processed by the data processing engine 106 to generate maintenance recommendations. This processing may involve complex algorithms that analyze trends, patterns, and anomalies in the data. The engine may use techniques such as predictive modeling, fault detection algorithms, or expert systems to interpret the data and identify potential maintenance needs or impending failures. The maintenance recommendations generated by the data processing engine 106 are not limited to immediate repair actions. They may include a range of suggestions such as scheduling preventive maintenance, ordering replacement parts in advance, adjusting inspection intervals, or modifying operational procedures to extend component life. These recommendations are designed to optimize maintenance schedules, reduce unplanned downtime, and improve overall aircraft reliability and safety.

The system 100 may incorporate a learning component that continuously improves its filtering and analysis capabilities over time. As more flight data is processed and maintenance outcomes are recorded, the system can refine its algorithms to better identify relevant data patterns and make more accurate predictions. This adaptive approach ensures that the system becomes increasingly effective at identifying potential issues and optimizing maintenance strategies as it gains more operational experience.

Further, the data processing engine 106 of the system 100 may receive historical operational data for each component of the aircraft. In an example, the historical operational data may be based on one or more of flight hours, fuel consumption, engine operating parameters, environmental conditions, maintenance actions, and faults in the components. In an example, the data processing engine 106 may process the historical operational data to determine deterioration of the health parameters of each of the plurality of components. Upon receiving the input data and the historical operational data, the data processing engine 106 may process the received input data, which is corresponding to the maintenance parameter of the components of the aircraft. By processing the input data, the data processing engine 106 may determine values of health parameters for each component of the aircraft. The health parameters of each component of the aircraft are critical for the aircraft safety as they are indicative of real-time condition and performance of each component. The data processing engine 106 may further assess the values of health parameters to check if the components are functioning properly. The assessment includes determining if any value of health parameter is beyond a safety threshold. Upon determining any value of health parameter beyond the safety threshold, the component associated to with said value may be ascertained to be in a serviceable window. In case the value of health parameter is beyond a critical safety threshold, the component associated to said value may be ascertained to be in a replacement window. In an example, the data processing engine 106 may process the input data to determine health parameters of each of the plurality of components for ascertaining, based on the health parameters, whether one or more of the plurality of components are in one of a serviceable window and a replacement window.

In an example, the data processing engine 106 may utilize various analytical techniques and algorithms to process the input data and the historical operational data. These techniques may include statistical analysis, machine learning models, and predictive algorithms to accurately determine the health parameters of each component. The data processing engine 106 may also employ data fusion techniques to integrate information from multiple sensors and data sources, providing a comprehensive view of each component's condition. In addition to determining whether components are in serviceable or replacement windows, the data processing engine 106 may also provide more granular assessments. For instance, it may categorize components into different levels of urgency for maintenance or replacement, such as “immediate attention required,” “monitor closely,” or “within normal operating parameters.” This nuanced approach allows for more efficient prioritization of maintenance tasks and resource allocation. The system 100 may also incorporate a predictive maintenance module that uses the processed data to forecast future component failures or degradation. By analyzing trends in the health parameters and historical data, the system can estimate the remaining useful life of components and suggest optimal maintenance schedules. This proactive approach can significantly reduce unscheduled downtime and improve overall aircraft reliability.

Furthermore, the data processing engine 106 may generate detailed reports and visualizations of the health parameters and maintenance recommendations. These outputs can be customized for different stakeholders, such as maintenance technicians, fleet managers, and executives, providing each group with the most relevant information in an easily digestible format.

On ascertaining few components of the aircraft to be in the serviceable window based on an assessment of the health parameters, real-time inventory data of spare components may be obtained by the data processing engine 106. The spare components are corresponding to the components in the serviceable window so that the spare components can be used either for the repair or for complete replacement of the components in the serviceable window. The spare components may include the entire component or a part of the component that needs repair or service.

When the components in the serviceable window and the real-time inventory data of spare components are available, the service location generation engine 212 may generate a list of service airports based on availability of the spare components. The service airports may be airports in proximity of location of the plurality of airports to a flight route of the aircraft and where the desired spare component is available. The service location generation engine 212 further transmits the list of service airports to a flight maintenance system of the aircraft for scheduling service of the components in the serviceable window. In an example, pilot of the aircraft on receiving the state of the components and the list of service airports for the servicing, may decide either to land on a nearby airport to get the components serviced or may prebook a service slot in one of the airports from the list for getting the components serviced in the due course. This ensures a balance between criticality to aircraft safety and operational efficiency. In an example, based on the awareness of the service airports and the components in the serviceable window, a maintenance schedule can be optimally created in an auto-setting mode by the other engines. The maintenance schedule includes optimal service times and locations for the components to be serviced or replaced.

The maintenance schedule generated by the system 100 takes into account various factors to optimize aircraft operations and minimize disruptions. These factors may include the criticality of the component, estimated time for repair or replacement, flight schedules, passenger commitments, and overall fleet management. By considering these elements, the system 100 can suggest the most efficient service plan that balances safety requirements with operational needs. In addition to scheduling maintenance, the system 100 may also provide recommendations for proactive measures to prevent potential issues. For instance, if a component is approaching the end of its serviceable window but is not yet critical, the system might suggest ordering the spare part in advance and scheduling maintenance during the next planned stopover. This approach helps in reducing unexpected downtimes and optimizes the use of resources.

The data processing engine 106 may also analyze historical maintenance data and component performance trends to predict future maintenance needs. This predictive maintenance capability allows airlines to plan ahead, potentially grouping multiple maintenance tasks together to minimize aircraft ground time. It also helps in optimizing inventory management by ensuring that commonly needed spare parts are stocked at strategic locations along frequently used flight routes.

The system 100 ability to provide real-time information and recommendations can significantly improve an airline's operational efficiency. For example, if an unexpected maintenance need arises during a flight, the system can quickly identify the nearest suitable airport with the required spare parts and technical capabilities. This rapid response capability can help minimize delays and reduce the impact on subsequent flights in the schedule.

Simultaneously, the data processing engine 106 may process the historical operational data in addition to the input data directed to the maintenance parameter. Such a processing by the data processing engine 106 identifies one or more components of the aircraft requiring either a service prior to a scheduled service time or a replacement prior to a scheduled replacement time. Service of a component indicates repair of the component without complete replacement. Replacement indicates complete change of the component. The data processing engine 106 processes the historical operational data to determine deterioration of the health parameters of each of the plurality of components. On identifying any such component, i.e., for service or replacement, the inventory updating engine 108 generates a replenishment notification. The replenishment notification is an indicative of replenishment of spare parts corresponding to the components requiring the service or the replacement. The inventory updating engine 108 further transmits the replenishment notification to an inventory management system associated with airports located in proximity to a flight route of the aircraft for optimally stocking inventories at the airports. The inventory management system may further trigger requirements to vendors or nearby airports for optimally stocking inventories at the airports for timely servicing or replacement of the components of the aircraft and ensuring that the right components are in the right place at the right time.

The inventory updating engine 108 plays a vital role in ensuring efficient supply chain management. Upon receiving information about components needing service or replacement, it not only generates replenishment notifications but also calculates optimal inventory levels. This calculation takes into account factors such as component criticality, lead times for procurement, and historical usage patterns.

The transmission of replenishment notifications to inventory management systems at nearby airports is a key feature of this system. It enables a network-wide approach to inventory management, ensuring that spare parts are available where they are most likely to be needed. This strategy minimizes the need for emergency shipments and reduces the risk of flight delays due to parts unavailability. The inventory management system at each airport uses the received notifications to optimize its stock levels. It may employ just-in-time inventory practices, balancing the need for immediate availability with the costs of maintaining excess inventory. The system can also initiate automated purchase orders to vendors when stock levels fall below predetermined thresholds.

Before processing the input data and the historical operational data, the data processing engine 106 applies a relevancy filter to the post-flight data for filtering data corresponding to the at least one maintenance parameter for each of the plurality of components of the aircraft. Additionally, other engines may perform a validation test on the input data and the historical operational data before initiating the processing to determine if the the input data and the historical operational data are compromised, i.e., includes a malicious program, a virus, modified data, and/or any suspicious data. Examples of suspicious data may include a file having a file size different than that of predetermined file size. In an example, the validity test may be a startup test that automatically performs a determination of compromised data once the system 100 is turned on. In an example, the validity test may be a continuous test. In the continuous test, determination of compromised data may take place continuously depending on the received data. In another example, the validity test may be an interactive test. In the interactive test, the user, such as the pilot, flight crew, may provide an input to initiate the validity test to determine if the data is compromised. The interactive test provides the user to initiate the validity test manually at any instant.

The data processing engine 106 ascertains any component of the aircraft 202 to be in a replacement window when the assessment of the health parameters indicates the values of the health parameters beyond a safety threshold. The safety threshold may be set as per the criticality of the component in the aircraft. For example, if the aircraft is operating in an extremely cold region, the safety threshold for a braking system of the aircraft may be different than being operating in a moderate or hot region.

In an example, the data processing engine 106 may compute reliability and availability metrics based on the input data and historical operational data of each of the plurality of components of the aircraft. The reliability and availability metrics are computed to forecast a repair window for each of the plurality of components of the aircraft and to forecast inventory replenishment in the service airports. In the aviation industry, the reliability and availability metrics are critical metrics that help airlines ensure operational efficiency and customer satisfaction. These metrics are essential for monitoring aircraft performance and maintenance, ultimately impacting profitability. In an example, the reliability and availability metrics are often quantified using several key metrics that may include, but is not limited to, mean time between failures (MTBF), mean time to repair (MTTR), and spare availability ratio (SAR). MTBF measures the average time an aircraft operates before experiencing a failure. MTTR measures the average time required to repair an aircraft after a failure. SAR is the percentage of time that a spare part is in stock and ready to be used when required. It is a critical performance indicator for service operations, affecting customer satisfaction and operational efficiency. The reliability and availability metrics thus estimates the probability of failure and the need for replacement for each component and system based on historical and current data.

When any component of the aircraft 202 is in a replacement window, the service location generating engine 212 may further determine a location of a nearest service airport amongst the list of service airports identified earlier by the service location generating engine 212. The nearest service airport is nearest from a current location of the aircraft. The nearest service airport is for scheduling immediate service of the one or more of the plurality of components in the replacement window. If the component in the replacement window is not replaced immediately, serious consequences may be faced by the aircraft and therefore by the occupants of the aircraft. The alert generation engine 214 may generate an alert signal to be transmitted to the nearest airport to stock the one or more of the plurality of components in the replacement window. In an example, the alert signal may include an inventory notification indicative of the one or more of the plurality of components in the replacement window.

In an example, on ascertaining the one or more components in the replacement window, the service location generating engine 212 may generate a signal to operate the aircraft in an autonomous mode for routing the aircraft to the nearest airport for immediate service of the one or more of the plurality of components in the replacement window. Such autonomous mode may not allow any manual intervention to keep the safety feature on utmost priority.

To forecast the inventory replenishment in the service airports, the system 100 may apply a machine learning technique. In an example, the machine learning technique is based on an artificial neural network. In an example, the machine learning technique is based on genetic algorithms. The machine learning techniques, such as artificial neural networks and genetic algorithms, are applied to forecast the demand and optimize the inventory levels of spare parts, taking into account the variability and uncertainty of the demand. The system 100 may utilize historical data, including past demand patterns, seasonal trends, and external factors such as flight schedules and maintenance records, to train the machine learning models. These models can then predict future demand for spare parts with greater accuracy, allowing for more efficient inventory management. In addition to forecasting demand, the machine learning techniques may also be used to optimize the distribution of spare parts across different service airports. This optimization takes into account factors such as the criticality of each part, storage costs, transportation times, and the likelihood of demand at each location. The artificial neural network approach may employ a multi-layer perceptron (MLP) architecture, with input layers processing various relevant features, hidden layers capturing complex relationships in the data, and output layers providing predictions for future spare part demands. The genetic algorithm approach may be used to evolve optimal inventory strategies over time. It can generate and evaluate multiple inventory allocation scenarios, selecting and refining the best-performing solutions to continuously improve the system's efficiency. The system 100 may also incorporate reinforcement learning techniques to adapt and improve its inventory management strategies over time based on real-world outcomes and feedback from actual spare part usage and replenishment cycles.

The system 100 considers multiple objectives and constraints in an inventory optimization problem, such as minimizing the total inventory cost, maximizing service level, and satisfying the availability and reliability requirements of the aircraft components. The system 100 thus provides a flexible and adaptive framework that can handle different types of aircraft, components, and data sources, and can be updated and improved with new data and algorithms.

In case of an emergency, such as avionics failure, structural impact due to severe weather, pilots need to quickly assess the availability of spare parts and the suitability of nearby airports for landing. The present system 100 in such a situation may validate the spare availability and suggest the best airport for emergency landing, based on the following criteria distance from the current location, runway length and condition, airport facilities and services, and availability of spare parts and maintenance personnel.

In an example, the other engines 216 may include a flight maintenance engine (not shown) to schedule a maintenance of the aircraft at the airports located in the proximity to the flight route of the aircraft when the one or more of the plurality of components requiring the service or the replacement. The flight maintenance engine, as part of the other engines 216, plays a crucial role in optimizing aircraft maintenance schedules. This engine utilizes the data processed by the data processing engine 106 and the service location information generated by the service location generation engine 212 to create efficient maintenance plans. For example, if the data processing engine 106 identifies that an aircraft's landing gear requires service within the next 500 flight hours, and the service location generation engine 212 has identified suitable service airports along the aircraft's upcoming flight routes, the flight maintenance engine can schedule the maintenance at the most convenient and cost-effective location and time.

The flight maintenance engine considers various factors when scheduling maintenance, including component criticality for components that are more critical to flight safety are given higher priority in scheduling, operational impact that aims to minimize disruption to regular flight operations, resource availability to consider the availability of necessary spare parts, maintenance personnel, and facilities at potential service locations, and regulatory compliance for ensuring that all scheduled maintenance adheres to aviation authority regulations and manufacturer recommendations. For instance, if an aircraft's auxiliary power unit (APU) is approaching its service window, the flight maintenance engine might schedule its maintenance during an overnight stop at an airport with available APU technicians and parts, minimizing impact on the flight schedule. The flight maintenance engine also facilitates predictive maintenance, which aims to perform maintenance activities before failures occur. By analyzing trends in the historical operational data and current health parameters of components, it can predict when a component is likely to fail and schedule maintenance accordingly. This approach can significantly reduce unscheduled maintenance events and improve overall aircraft reliability. In addition to scheduling component-specific maintenance, the flight maintenance engine may also coordinate broader maintenance checks that involve increasingly comprehensive inspections and maintenance activities. The flight maintenance engine would schedule these checks based on the aircraft's flight hours, cycles, and calendar time, ensuring compliance with regulatory requirements while optimizing operational efficiency. The flight maintenance engine may also interface with the inventory management system to ensure that necessary parts are available at the scheduled maintenance location. If a required part is not available, the engine might adjust the maintenance schedule or coordinate with the inventory updating engine 108 to arrange for the part to be delivered to the maintenance location. By integrating with other systems, such as crew scheduling and flight planning systems, the flight maintenance engine can create holistic maintenance plans that consider all aspects of airline operations. This integration helps in minimizing aircraft downtime, reducing maintenance costs, and improving overall fleet utilization.

In the context of urban air mobility (UAM) vehicles, the flight maintenance engine may need to adapt to unique maintenance requirements. For example, electric vertical takeoff and landing (eVTOL) aircraft used in UAM operations may require more frequent battery checks and replacements. The flight maintenance engine would need to account for these specific needs when scheduling maintenance for such vehicles.

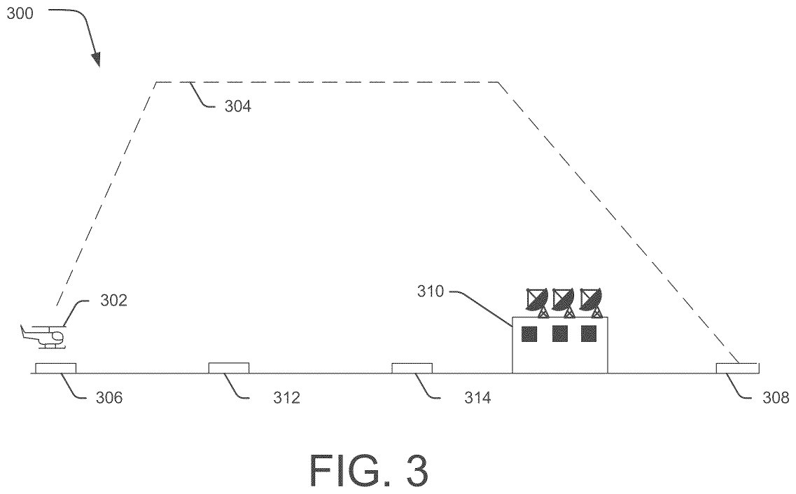

FIG. 3 illustrates an environment 300 where a UAM vehicle 302 is operating, according to an example. The UAM vehicle 302 is similar to the aircraft 202 of FIG. 2. In an example, the UAM vehicle 302 may have to fly on a flight route 304 from take-off point 306 to a landing point 308. The flight route 304 is depicted with a dashed line in FIG. 3. In an example, the UAM vehicle 302 is communicably coupled to the system 100 via the network 206. When the UAM vehicle 302 starts from the take-off point 306, the system 100 initiates its operation. In an example, the system 100 initiates its operation when the UAM vehicle 302 is stationed at the take-off point 306.

During the operation, the system 100 processes the input data corresponding to maintenance parameters of components of the UAM vehicle 302. Basis of the input data may be post-flight data obtained from latest flight of the aircraft, i.e., most recent flight's post-flight data extracted and stored in the database during post flight analytics. The input data represents real-time state of components of the UAM vehicle 302. Simultaneously, the historical operational data for each component of the UAM vehicle 302 may be processed. By processing the input data and the historical operational data, values of health parameters for each component of the UAM vehicle 302 may be determined. The health parameters of each component of the aircraft are critical for the aircraft safety as they are indicative of real-time condition and performance of each component. The health parameters are assessed for determining the serviceability or the replaceability of any component of the UAM vehicle 302 For example, upon determining any value of health parameter beyond a safety threshold, the component associated to with said value may be ascertained to be in a serviceable window. In case the value of health parameter is beyond a critical safety threshold, the component associated to said value may be ascertained to be in a replacement window. On forecasting the service or the replacement requirement, real-time inventory data of spare components may be obtained from an inventory management system 310 associated with a first airport 312, a second airport 314, the take-off point 306, and the landing point 308. The take-off point 306 and the landing point 308 may also be referred to as airports. The first airport 312, the second airport 314, the take-off point 306, and the landing point 308 are associated with the flight route 304 of the UAM vehicle 302. For example, the first airport 312, the second airport 314, the take-off point 306, and the landing point 308 are airports in proximity of location to a flight route of the UAM vehicle 302.

When the components that need the service or the replacement and the real-time inventory data of spare components are available, a list of service airports based on availability of the spare components may be generated. For example, if the second airport 314 and the landing point 308 have the required spare parts, the list of service airports will include the second airport 314 and the landing point 308. The coordinates of the second airport 314 and the landing point 308 may be communicated to a flight maintenance system of the UAM vehicle 302. The UAM vehicle 302 either automatically or with pilot intervention may decide whether to land at the second airport 314 for the servicing or to go directly to the landing point 308 where the servicing is possible.

In parallel, the inventory management system receives a replenishment notification associated with airports located in proximity to a flight route of the UAM vehicle 302 for optimally stocking inventories at the airports. The inventory management system may further trigger requirements to vendors or nearby airports for optimally stocking inventories at the airports for timely servicing or replacement of the components of the aircraft and ensuring that the right components are in the right place at the right time.

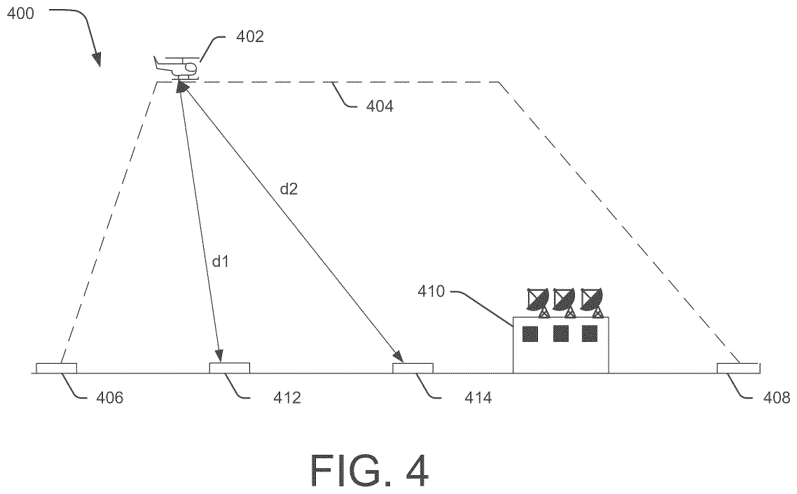

FIG. 4 illustrates an environment 400 where a UAM vehicle 402 is operating, according to an example. The UAM vehicle 402 is similar to the UAM vehicle 302 of FIG. 3. In an example, the UAM vehicle 402 is flying on a flight route 404 from take-off point 406 to a landing point 408. The flight route 404 is depicted with a dashed line in FIG. 4. In an example, the UAM vehicle 402 is communicably coupled to the system 100 via the network 206. When the UAM vehicle 402 starts from the take-off point 406, the system 100 initiates its operation. In an example, the system 100 initiates its operation when the UAM vehicle 402 is stationed at the take-off point 406. The list of service airports may be generated by the system 100 like being done for the UAM vehicle 302 of FIG. 3. The list of service airports may include a first airport 412 and a second airport 414 based on the availability of the required spare parts as confirmed by an inventory management system 410 and proximity to the flight route 404.

In case of an emergency, such as avionics failure, structural impact due to severe weather, pilots need to quickly assess the availability of spare parts and the suitability of nearby airports for landing. The present system 100 in such a situation may validate the spare availability and suggest the best airport for emergency landing, based on the following criteria distance from the current location, runway length and condition, airport facilities and services, and availability of spare parts and maintenance personnel. For example, the system may calculate a first distance d1 between the UAM vehicle current position and the first airport 412 and may further calculate a second distance d2 between the UAM vehicle current position and the second airport 414. Based on the shortest distance by comparing the first distance d1 and the second distance d2, the system 100 will transmit a rescue route to the UAM vehicle 402 for getting the faulty component replaced in a shortest possible time. That is to say, a location of a nearest service airport amongst the list of service airports identified earlier by the system 100 may be determined. The nearest service airport is nearest from a current location of the UAM vehicle 402. In an example, on ascertaining the one or more components in the replacement window, a signal may be generated to operate the UAM vehicle 402 in an autonomous mode for routing the UAM vehicle 402 to the nearest airport, for example, at the first airport 412 if d1 is less than d2 for immediate service of the one or more of the plurality of components in the replacement window. In an example, such autonomous mode may not allow any manual intervention to keep the safety feature on utmost priority.

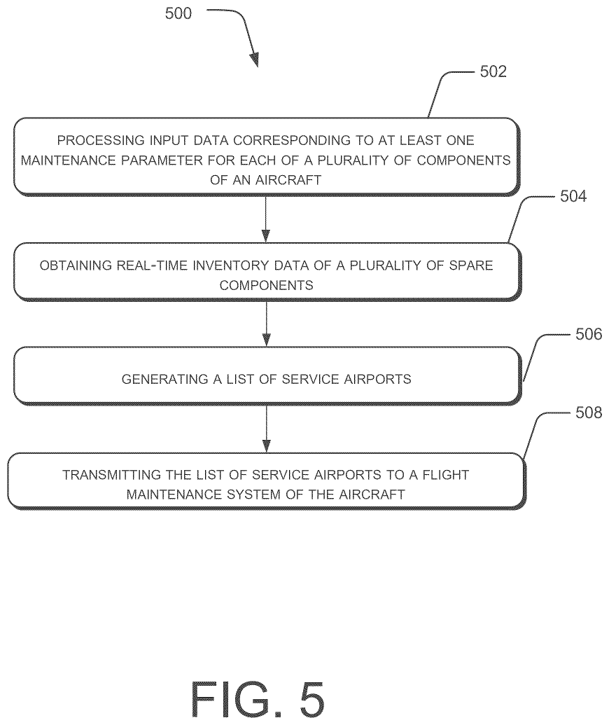

FIG. 5 illustrates a method 500 for aircraft service management, according to an example. The order in which the above-mentioned methods are described is not intended to be construed as a limitation, and some of the described method blocks may be combined in a different order to implement the method, or an alternative method.

Furthermore, the above-mentioned method may be implemented in a suitable hardware, computer-readable instructions, or combination thereof. The steps of such methods may be performed by either a system under the instruction of machine executable instructions stored on a non-transitory computer readable medium or by dedicated hardware circuits, microcontrollers, or logic circuits. Herein, some examples are also intended to cover non-transitory computer readable medium, for example, digital data storage media, which are computer readable and encode computer-executable instructions, where the instructions perform some or all the steps of the above-mentioned method.

Referring to FIG. 5, the method 500 may be implemented by a system for aircraft service management. The system may be similar to the system 100 of FIG. 1.

At block 502, the method includes processing input data corresponding to at least one maintenance parameter for each of a plurality of components of an aircraft to determine values of health parameters for each of the plurality of components of the aircraft. The input data is generated based on post-flight data obtained from latest flight of the aircraft. The health parameters are indicative of real-time condition and performance of each of the plurality of components. In an example, the post-flight data is based on one or more of flight hours, fuel consumption, engine operating parameters, environmental conditions, maintenance actions, and faults in the components. The input data generated based on the post-flight data is a real-time indicative of state of components of the aircraft. The post-flight data can be extracted and stored in the database during post flight analytics. The data collection can be from aircraft sensors, logs, and reports. The data collection can also be from passenger feedback, crew reports, fuel consumption, and maintenance records. The input data may be processed to further determine values of health parameters for each component of the aircraft. The health parameters of each component of the aircraft are critical for the aircraft safety as they are indicative of real-time condition and performance of each component. The assessment includes determining if any value of health parameter is beyond a safety threshold. Upon determining any value of health parameter beyond the safety threshold, the component may be ascertained to be in a serviceable window. In case the value of health parameter is in a danger threshold, the component associated may be ascertained to be in a replacement window.

At block 504, the method includes obtaining real-time inventory data of a plurality of spare components corresponding to the one or more components in the serviceable window. The real-time inventory data is obtained on ascertaining one or more components, of the plurality of components, to be in a serviceable window based on an assessment of the health parameters. The spare components are corresponding to the components in the serviceable window so that the spare components can be used either for the repair or for complete replacement of the components in the serviceable window.

At block 506, the method includes generating a list of service airports from among a plurality of airports based on availability of one or more of the plurality of spare components at the plurality of airports and proximity of location of the plurality of airports to a flight route of the aircraft. The service airports may be airports in proximity of location of the plurality of airports to a flight route of the aircraft and where the desired spare component is available as can also be seen in FIGS. 3 and 4.

At block 508 of FIG. 5, the method includes transmitting the list of service airports to a flight maintenance system of the aircraft for scheduling service of the one or more of the plurality of components in the serviceable window. For example, on receiving the state of the components and the list of service airports for the servicing, the pilot of the aircraft or a maintenance system of the aircraft may decide either to land on a nearby airport to get the components serviced or may prebook a service slot in one of the airports from the list for getting the components serviced in the due course. This ensures a balance between criticality to aircraft safety and operational efficiency.

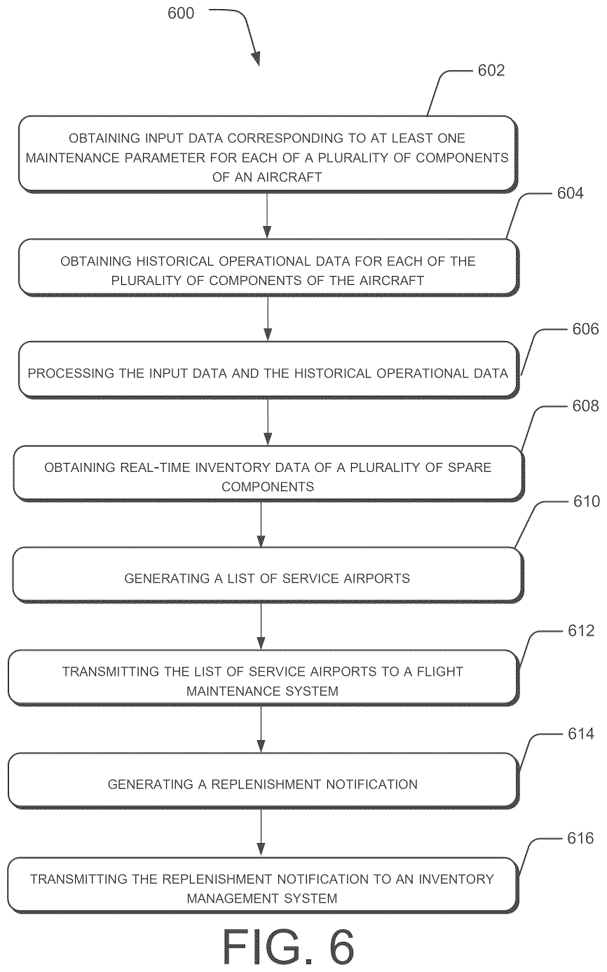

FIG. 6 illustrates a method 600 for aircraft service management, according to an example. The order in which the above-mentioned methods are described is not intended to be construed as a limitation, and some of the described method blocks may be combined in a different order to implement the method, or an alternative method.

Furthermore, the above-mentioned method may be implemented in a suitable hardware, computer-readable instructions, or combination thereof. The steps of such methods may be performed by either a system under the instruction of machine executable instructions stored on a non-transitory computer readable medium or by dedicated hardware circuits, microcontrollers, or logic circuits. Herein, some examples are also intended to cover non-transitory computer readable medium, for example, digital data storage media, which are computer readable and encode computer-executable instructions, where the instructions perform some or all the steps of the above-mentioned method.

Referring to FIG. 6, the method 600 may be implemented by a system for aircraft service management. The system may be similar to the system 100 of FIG. 1.

At block 602, the method includes obtaining input data corresponding to at least one maintenance parameter for each of a plurality of components of an aircraft. In an example, aircraft may be an urban air mobility (UAM) vehicle. Examples of UAM vehicle may include, but are not limited to, helicopters, vertical take-off and landing (VTOL) aircraft, and unmanned aerial vehicles (UAVs). The components may include any part involved in the manufacturing of the aircraft and in the operation of the aircraft. The components may include avionics including, but is not limited to, flight management systems, engine controls, flight control systems, navigation, communications, flight recorders, lighting systems, threat detection, fuel systems, electro-optic systems, weather radar, etc. Specifically. the input data may be generated based on post-flight data obtained from latest flight of the aircraft. The latest flight may be the most recent flight's post-flight data. The post-flight data collection can be done from aircraft sensors, logs, and reports. In an example, passenger feedback, crew reports, fuel consumption, and maintenance records may be sources for the post-flight data collection. In an example, the post-flight data may be based on one or more of flight hours, fuel consumption, engine operating parameters, environmental conditions, maintenance actions, and faults in the components. The post-flight data helps in providing a real-time indicative of state of components of the aircraft. In an example, the post-flight data may be obtained by applying a post-flight analytical technique selected from a descriptive analytical technique, a predictive analytical technique, and a prescriptive analytical technique. Such—flight analytical technique can help to summarize the past performance and trends of the inventory, forecast the future demand and supply of the inventory, based on factors such as seasonality, weather, route, flight duration, and passenger profile, and generate optimal recommendations and actions for the inventory, such as the optimal quantity, quality, and variety of each item, as well as the optimal price, promotion, and placement of the items. The post flight data analytics can reflect the actual and potential demand of spare parts.

At block 604, the method 600 includes obtaining historical operational data for each plurality of components of the aircraft. In an example, the historical operational data may be based on one or more of flight hours, fuel consumption, engine operating parameters, environmental conditions, maintenance actions, and faults in the components. Additionally, a relevancy filter may be applied to the post-flight data for filtering data corresponding to the at least one maintenance parameter for each of the plurality of components of the aircraft. The relevancy filter is applied to remove noise from the post-flight data so that unnecessary computation of the unnecessary data may be avoided. In parallel, the relevancy filter may be applied to the historical operational data for filtering data. The relevancy filter is applied to remove noise from the historical operational data so that unnecessary computation of the unnecessary data may be avoided.

At block 606, the method 600 includes processing the input data and the historical operational data. By processing the input data, values of health parameters for each component of the aircraft may be determined. The health parameters of each component of the aircraft are critical for the aircraft safety as they are indicative of real-time condition and performance of each component. Further assessment of the values of health parameters may be performed to check if the components are functioning properly. The assessment includes ascertaining the component to be in a serviceable window or in a replacement window. By processing the historical operational data, one or more components of the aircraft requiring either a service prior to a scheduled service time or a replacement prior to a scheduled replacement time may be identified. The service can be done by repairing of the component without complete replacement. The replacement indicates complete change of the component. The historical operational data may also determine deterioration of the health parameters of each of the plurality of components.

Further at block 608, the method 600 includes obtaining real-time inventory data of a plurality of spare components on ascertaining few components of the aircraft to be in the serviceable window based on an assessment of the health parameters. The spare components are corresponding to the components in the serviceable window so that the spare components can be used either for the repair or for complete replacement of the components in the serviceable window.

At block 610, the method includes generating a list of service airports based on availability of the spare components. When the components in the serviceable window and the real-time inventory data of spare components are available, such a list may be generated. The service airports may be airports in proximity of location of the plurality of airports to a flight route of the aircraft and where the desired spare component is available. The list of service airports is transmitted to a flight maintenance system of the aircraft at block 612 of the method 600. Such a transmission of the list is performed for scheduling service of the components in the serviceable window. Based on the list of service airports, the aircraft may either land on a nearby airport to get the components serviced or may prebook a service slot in one of the airports from the list for getting the components serviced in the due course. Based on the awareness of the service airports and the components in the serviceable window, a maintenance schedule can be optimally created, for example, in an auto-setting mode or by manual control of the pilot of the aircraft.

At block 614, the method 600 includes generating a replenishment notification on identifying any such component, i.e., for service or replacement. The replenishment notification is regarding replenishment of spare parts corresponding to the components requiring the service or the replacement. Further, at block 616, the replenishment notification gets transmitted to an inventory management system associated with airports located in proximity to a flight route of the aircraft for optimally stocking inventories at the airports. The inventory management system may further trigger requirements to vendors or nearby airports for optimally stocking inventories at the airports for timely servicing or replacement of the components of the aircraft and ensuring that the right components are in the right place at the right time.

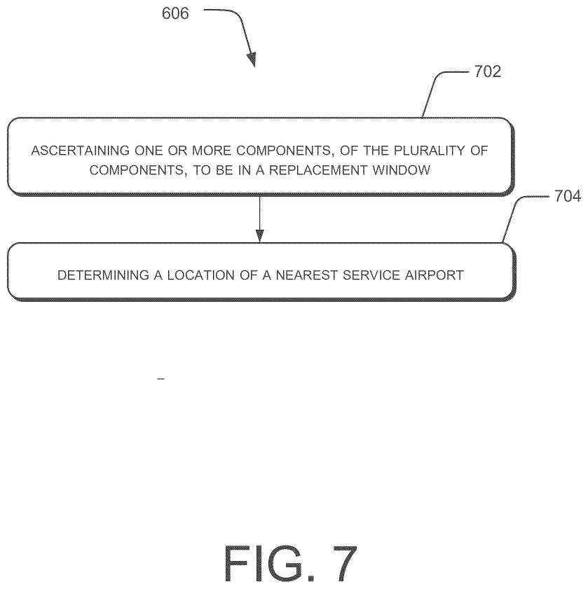

Further, an example implementation is depicted in FIG. 7, where the input data and the historical operational data are processed.

At block 702, any component of the aircraft may be ascertained to be in a replacement window when the assessment of the health parameters indicates the values of the health parameters beyond a safety threshold. The safety threshold may be set as per the criticality of the component in the aircraft. For example, if the aircraft is operating in an extremely hot region, the safety threshold for a cooling system of the aircraft may be different than being operating in a moderate or cold region. Further, reliability and availability metrics may be computed based on the input data and historical operational data of each of the plurality of components of the aircraft. The reliability and availability metrics are computed to forecast a repair window for each of the plurality of components of the aircraft and to forecast inventory replenishment in the service airports. These metrics are essential for monitoring aircraft performance and maintenance, ultimately impacting profitability. In an example, the reliability and availability metrics are often quantified using several key metrics that may include, but is not limited to, mean time between failures (MTBF), mean time to repair (MTTR), and spare availability ratio (SAR). The reliability and availability metrics thus estimates the probability of failure and the need for replacement for each component and system based on historical and current data.

At block 704, on determining any component of the aircraft is in a replacement window, a location of a nearest service airport amongst the list of service airports identified earlier may be determined. The nearest service airport is nearest from a current location of the aircraft as can be seen in FIG. 4 where the nearest airport is identified. The nearest service airport is for scheduling immediate service of the one or more of the plurality of components in the replacement window. If the component in the replacement window is not replaced immediately, serious consequences may be faced by the aircraft and therefore by the occupants of the aircraft. After determining the location of the nearest airport, an alert signal to be transmitted to the nearest airport may be generated. The nearest airport may initiate stocking the one or more of the plurality of components in the replacement window so that after the replacement of the component, the same remains in stock for any upcoming requirement. In an example, the alert signal may include an inventory notification indicative of the one or more of the plurality of components in the replacement window. In urgent situation when any critical component needs replacement, a signal may be generated to operate the aircraft in an autonomous mode for routing the aircraft to the nearest airport for immediate service of the one or more of the plurality of components in the replacement window. The inventory replenishment in the service airports may be forecasted by applying a machine learning technique. The machine learning techniques, such as artificial neural networks and genetic algorithms, are applied to forecast the demand and optimize the inventory levels of spare parts, taking into account the variability and uncertainty of the demand. The methods of the invention provides a flexible and adaptive framework that can handle different types of aircraft, components, and data sources, and can be updated and improved with new data and algorithms.

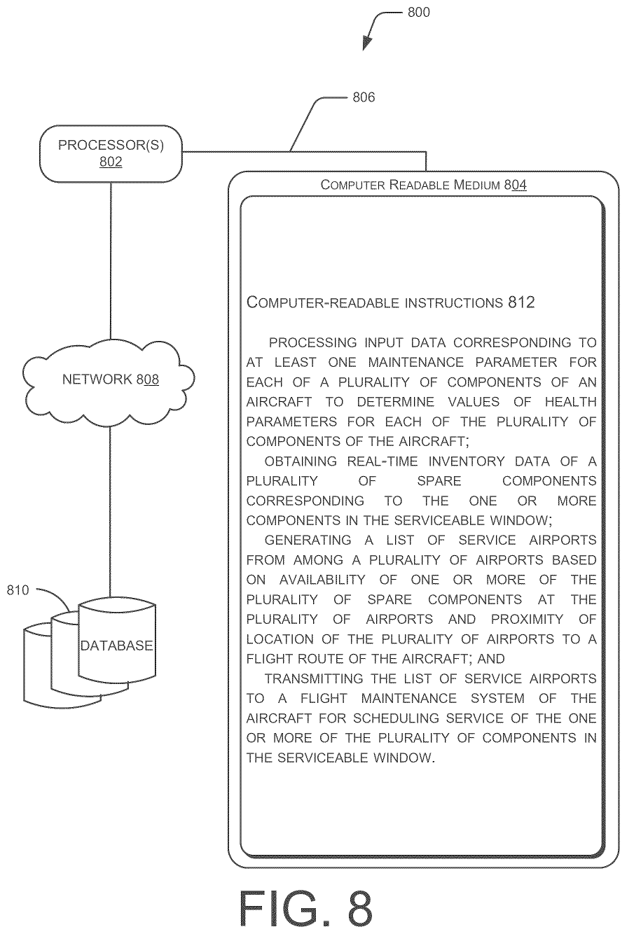

FIG. 8 illustrates a system environment 800 implementing a non-transitory computer readable medium for scheduling service of components in serviceable window, according to an example. In an example, the system environment 800 includes processor(s) 802 communicatively coupled to a non-transitory computer readable medium 804 through a communication link 806. In an example, the processor(s) 802 may have one or more processing resources for fetching and executing computer-readable instructions from the non-transitory computer readable medium 804. The processor(s) 802 and the non-transitory computer readable medium 804 may be implemented, for example, in the system 100 (as has been described in conjunction with the preceding figures).

The non-transitory computer readable medium 804 may be, for example, an internal memory device or an external memory device. In an example implementation, the communication link 806 may be a network communication link. The processor(s) 802 may access the non-transitory computer readable medium 804 through a network 808. The network 808 may be a single network or a combination of multiple networks and may use a variety of communication protocols. The processor(s) 802 and the non-transitory computer readable medium 804 may also be communicatively coupled to a data source 810 over the network 808. The data source 810 may include, for example, a database.

In an example implementation, the non-transitory computer readable medium 804 includes a set of computer readable instructions (hereinafter may also be referred as instructions) 812 which may be accessed by the processor(s) 802 through the communication link 806. Referring to FIG. 8, in an example, the non-transitory computer readable medium 804 includes instructions 812 that may cause the processor(s) 802 to process input data corresponding to at least one maintenance parameter for each of a plurality of components of an aircraft to determine values of health parameters for each of the plurality of components of the aircraft. The input data is generated based on post-flight data obtained from latest flight of the aircraft. The health parameters are indicative of real-time condition and performance of each of the plurality of components. In an example, the post-flight data is based on one or more of flight hours, fuel consumption, engine operating parameters, environmental conditions, maintenance actions, and faults in the components. The input data generated based on the post-flight data is a real-time indicative of state of components of the aircraft. The post-flight data can be extracted and stored in the database during post flight analytics. The data collection can be from aircraft sensors, logs, and reports. The data collection can also be from passenger feedback, crew reports, fuel consumption, and maintenance records. The input data may be processed to further determine values of health parameters for each component of the aircraft. The health parameters of each component of the aircraft are critical for the aircraft safety as they are indicative of real-time condition and performance of each component. The assessment includes determining if any value of health parameter is beyond a safety threshold. Upon determining any value of health parameter beyond the safety threshold, the component may be ascertained to be in a serviceable window. In case the value of health parameter is in a danger threshold, the component associated may be ascertained to be in a replacement window. In an example, the instructions cause the processor to perform operations comprising applying a relevancy filter to the post-flight data for filtering data corresponding to the at least one maintenance parameter for each of the plurality of components of the aircraft.

On ascertaining one or more components, of the plurality of components, to be in a serviceable window based on an assessment of the health parameters, the instructions 812 may cause the processor(s) 802 to obtain real-time inventory data of a plurality of spare components corresponding to the one or more components in the serviceable window. The spare components are corresponding to the components in the serviceable window so that the spare components can be used either for the repair or for complete replacement of the components in the serviceable window.

The instructions 812 may cause the processor(s) 802 to generate a list of service airports from among a plurality of airports based on availability of one or more of the plurality of spare components at the plurality of airports and proximity of location of the plurality of airports to a flight route of the aircraft. The service airports may be airports in proximity of location of the plurality of airports to a flight route of the aircraft.

The instructions 812 may further cause the processor(s) 802 to transmit the list of service airports to a flight maintenance system of the aircraft for scheduling service of the one or more of the plurality of components in the serviceable window. For example, on receiving the state of the components and the list of service airports for the servicing, the pilot of the aircraft or a maintenance system of the aircraft may decide either to land on a nearby airport to get the components serviced or may prebook a service slot in one of the airports from the list for getting the components serviced in the due course. This ensures a balance between criticality to aircraft safety and operational efficiency.

The instructions 812 may further cause the processor(s) 802 to ascertain one or more components, of the plurality of components, to be in a replacement window when the assessment of the health parameters indicate the values of the health parameters beyond a safety threshold. The instructions 812 may further cause the processor(s) 802 to determine a location of a nearest service airport, amongst the list of service airports, from a current location of the aircraft for scheduling immediate service of the one or more of the plurality of components in the replacement window.

Although examples for the present disclosure have been described in language specific to structural features and/or methods, it is to be understood that the appended claims are not necessarily limited to the specific features or methods described. Rather, the specific features and methods are disclosed and explained as examples of the present disclosure.

We claim:

1. A method comprising:
processing input data corresponding to at least one maintenance parameter for each of a plurality of components of an aircraft to determine values of health parameters for each of the plurality of components of the aircraft, wherein the input data is generated based on post-flight data obtained from latest flight of the aircraft, and wherein the health parameters are indicative of real-time condition and performance of each of the plurality of components;
on ascertaining one or more components, of the plurality of components, to be in a serviceable window based on an assessment of the health parameters, obtaining real-time inventory data of a plurality of spare components corresponding to the one or more components in the serviceable window;
generating a list of service airports from among a plurality of airports based on availability of one or more of the plurality of spare components at the plurality of airports and proximity of location of the plurality of airports to a flight route of the aircraft; and
transmitting the list of service airports to a flight maintenance system of the aircraft for scheduling service of the one or more of the plurality of components in the serviceable window.

2. The method as claimed in claim 1, wherein the method comprises:
ascertaining one or more components, of the plurality of components, to be in a replacement window when the assessment of the health parameters indicate the values of the health parameters beyond a safety threshold; and
determining a location of a nearest service airport, amongst the list of service airports, from a current location of the aircraft for scheduling immediate service of the one or more of the plurality of components in the replacement window.

3. The method as claimed in claim 2, wherein the method comprises, on ascertaining the one or more components in the replacement window, generating a signal to operate the aircraft in an autonomous mode for routing the aircraft to the nearest airport for immediate service of the one or more of the plurality of components in the replacement window.

4. The method as claimed in claim 2, wherein the method comprises generating an alert signal to be transmitted to the nearest airport to stock the one or more of the plurality of components in the replacement window, wherein the alert signal comprises an inventory notification indicative of the one or more of the plurality of components in the replacement window.

5. The method as claimed in claim 1, wherein the method comprises computing reliability and availability metrics based on the input data and historical operational data of each of the plurality of components of the aircraft, wherein the reliability and availability metrics are to forecast a repair window for each of the plurality of components of the aircraft and to forecast inventory replenishment in the service airports.

6. The method as claimed in claim 5, wherein the reliability and availability metrics are one of mean time between failures (MTBF), mean time to repair (MTTR), and spare availability ratio (SAR).

7. The method as claimed in claim 1, wherein the method comprises applying a machine learning technique to forecast an inventory replenishment in the service airports.

8. The method as claimed in claim 7, wherein the machine learning technique is based on an artificial neural network.

9. The method as claimed in claim 1, wherein the post-flight data is based on one or more of flight hours, fuel consumption, engine operating parameters, environmental conditions, maintenance actions, and faults in the components.

10. The method as claimed in claim 1, wherein the method comprises obtaining the post-flight data utilizing a post-flight analytical technique selected from one of a descriptive analytical technique, a predictive analytical technique, and a prescriptive analytical technique.

11. The method as claimed in claim 1, wherein the method comprises applying a relevancy filter to the post-flight data for filtering data corresponding to the at least one maintenance parameter for each of the plurality of components of the aircraft.

12. A system comprising:
a data processing engine to:
obtain input data corresponding to at least one maintenance parameter for each of a plurality of components of an aircraft, wherein the input data is generated based on post-flight data obtained from latest flight of the aircraft;
obtain historical operational data for each of the plurality of components of the aircraft; and
process the input data and the historical operational data to identify one or more components, from the plurality of components, requiring one of:
a service prior to a scheduled service time, and
a replacement prior to a scheduled replacement time; and
an inventory updating engine to:
generate a replenishment notification indicative of replenishment of spare parts corresponding to the one or more of the plurality of components requiring the service or the replacement; and
transmit the replenishment notification to an inventory management system associated with airports located in proximity to a flight route of the aircraft for optimally stocking inventories at the airports.

13. The system as claimed in claim 12, wherein the data processing engine is to process the input data to determine health parameters of each of the plurality of components for ascertaining, based on the health parameters, whether one or more of the plurality of components are in one of a serviceable window and a replacement window.

14. The system as claimed in claim 12, wherein the data processing engine is to process the historical operational data to determine deterioration of the health parameters of each of the plurality of components.

15. The system as claimed in claim 12, wherein the system comprises a flight maintenance engine to schedule a maintenance of the aircraft at the airports located in the proximity to the flight route of the aircraft when the one or more of the plurality of components requiring the service or the replacement.

16. The system as claimed in claim 12, wherein the inventory updating engine is to apply a machine learning technique to generate the replenishment notification for forecasting an inventory replenishment at the airports.

17. A non-transitory computer readable medium having instructions stored thereon, the instructions, when executed by a processor, cause the processor to perform operations comprising:
processing input data corresponding to at least one maintenance parameter for each of a plurality of components of an aircraft to determine values of health parameters for each of the plurality of components of the aircraft, wherein the input data is generated based on post-flight data obtained from latest flight of the aircraft, and wherein the health parameters are indicative of real-time condition and performance of each of the plurality of components;
on ascertaining one or more components, of the plurality of components, to be in a serviceable window based on an assessment of the health parameters, obtaining real-time inventory data of a plurality of spare components corresponding to the one or more components in the serviceable window;
generating a list of service airports from among a plurality of airports based on availability of one or more of the plurality of spare components at the plurality of airports and proximity of location of the plurality of airports to a flight route of the aircraft; and
transmitting the list of service airports to a flight maintenance system of the aircraft for scheduling service of the one or more of the plurality of components in the serviceable window.

18. The non-transitory computer readable medium as claimed in claim 17, wherein the instructions cause the processor to perform operations comprising:
ascertaining one or more components, of the plurality of components, to be in a replacement window when the assessment of the health parameters indicate the values of the health parameters beyond a safety threshold; and
determining a location of a nearest service airport, amongst the list of service airports, from a current location of the aircraft for scheduling immediate service of the one or more of the plurality of components in the replacement window.

19. The non-transitory computer readable medium as claimed in claim 17, wherein the instructions cause the processor to perform operations comprising applying a relevancy filter to the post-flight data for filtering data corresponding to the at least one maintenance parameter for each of the plurality of components of the aircraft.

20. The non-transitory computer readable medium as claimed in claim 17, wherein the post-flight data is based on one or more of flight hours, fuel consumption, engine operating parameters, environmental conditions, maintenance actions, and faults in the components.
